(19) United States
(12) Patent Application Publication
(10) Pub. No.: US 2002/0033149 A1
(43) Pub. Date: Mar. 21, 2002

(54) Cooling system for cylinder liner

(75) Inventors: Hideo Negishi, Hino-shi (JP); Shinichi Sasaki, Hino-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: HINO MOTORS LTD., Hino-shi (JP)

(21) Appl. No.: 09/953,867

(22) Filed: Sep. 18, 2001

(30) Foreign Application Priority Data
Sep. 19, 2000 (JP) 2000-282903

(51) Int. Cl. F02F 1/10

(52) U.S. Cl. 123/41.83

(57) ABSTRACT

An oil groove is formed on a top deck of a cylinder block to surround a cylinder liner such that the groove does not substantially extend deeper beyond cylindrical load plane of a seal ring on a head gasket, which prevents a clamp-down load of the gasket from acting as a bending load on an upper wall of the groove. The cylinder liner, which receives a great amount of heat transmitted from a top ring on a piston when the latter is near and at its top dead center position, can be effectively cooled without deformation of the cylinder block and/or the cylinder liner even if the top ring is positioned at an elevated position for the purpose of attaining a high compression ratio.

### BACKGROUND OF THE INVENTION

1. Field of the Invention

This invention relates to a cooling system for a cylinder liner. More particularly, it relates to a cooling system capable of attaining an improved cooling effect on a cylinder liner which receives heat from a top ring on a piston.

2. Detailed Description of the Related Art

In an internal combustion engine, a water jacket in a cylinder block cannot extend to a top deck of the block from the viewpoint of structural strength. However, at the very top deck, a cylinder liner on the block will receive a great amount of heat transmitted from a top ring on a piston when the latter is near and at its top dead center position. Therefore, as shown in FIG. 1, in a conventional system, an oil groove 2 is formed on a top deck of a cylinder block 3 to surround a cylinder liner 1 and some of the engine oil from a main oil gallery (not shown) is circulated through the groove 2 to suppress any temperature rise of the liner 1 due to the heat from a top ring 4 on a piston 7 when the latter is near and at its top dead center position.

Conventionally, the oil groove 2 is formed to extend deeper beyond cylindrical load plane a of a seal ring on a head gasket 5. Provision of the groove 2 on the cylinder block 3 at a level in accordance with the top ring 4 on the piston 7 when the latter is near and at its top dead center position as shown in FIG. 1 causes a flange 6 of the liner 1 to be supported by the top deck of the block 3 at its portion which has a substantially reduced thickness due to the groove 2 and hence has reduced rigidity.

A clamp-down load of the head gasket 5, therefore, may bend the top deck of the cylinder block 3 through the flange 6 so that both the top deck and the flange 6 are deflected downward in a manner as indicated by broken lines in FIG. 1. This may cause a concentrated stress on a base portion of the flange 6, resulting in formation of cracks. Therefore, to provide the top ring 4 on the piston 7 at an elevated level for the purpose of attaining a high compression ratio, is limitative itself. In FIG. 1, reference numerals 8 and 9 denote a water jacket and a cylinder head, respectively.

The present invention was made in view of the above and has its object to provide a cooling system capable of reliably cooling a cylinder liner, which receives a great amount of heat transmitted from a top ring on a piston when the latter is near and at its top dead center position, with no deformation of a cylinder block and/or the cylinder liner even if the top ring is provided on the piston at an elevated level for the purpose of attaining a high compression ratio.

### BRIEF SUMMARY OF THE INVENTION

For this purpose, the invention provides a cooling system for a cylinder liner in which an oil groove is formed on a top deck of a cylinder block to surround the cylinder liner such that the groove does not substantially extend deeper beyond cylindrical load plane of a seal ring on a head gasket.

A preferred embodiment of the invention will be described with reference to the drawings.

### BRIEF DESCRIPTION OF THE DRAWINGS

FIG. 1 is a segmentary sectional view of a cooling system for a cylinder liner according to a conventional example; and

FIG. 2 is a segmentary sectional view of an embodiment of a cooling system for a cylinder liner according to the invention.

### DETAILED DESCRIPTION OF THE PREFERRED EMBODIMENT

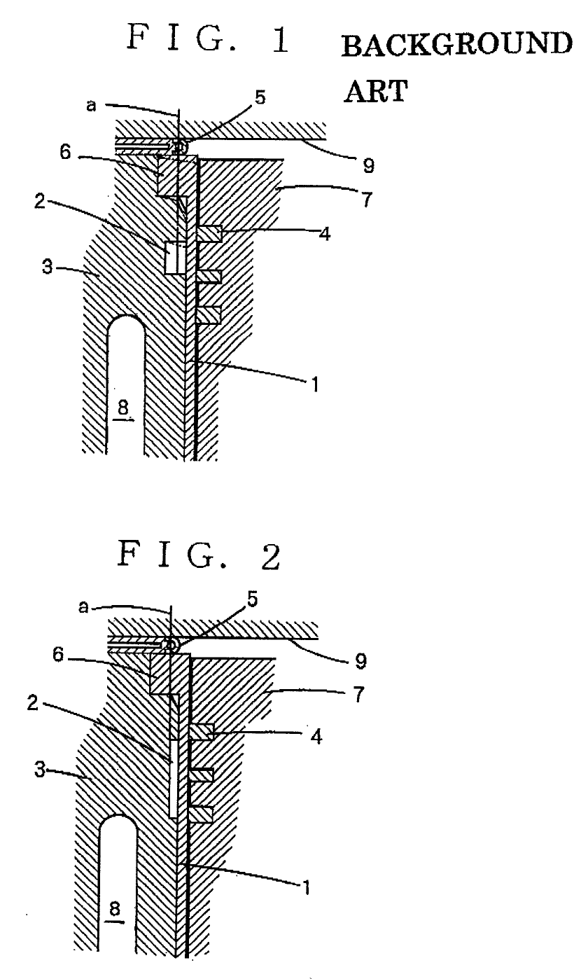

FIG. 2 is a segmentary sectional view of an embodiment of a cooling system for a cylinder liner according to the invention. In FIG. 2, components which are the same as or similar to those of the conventional system of FIG. 1 are denoted by the same reference numerals. Description on these components will be omitted.

In this embodiment, an oil groove 2 formed on a top deck of a cylinder block 3 to surround a cylinder liner 1 has upper, lower and side walls, the side wall defining a depth of the groove 2; the groove 2 is formed such that its depth-defining side wall is substantially aligned with the cylindrical load plane a of the seal ring on the head gasket 5. This prevents a clamp-down load of the gasket 5 from acting as a bending load to the upper wall of the groove 2.

Thus, with the above embodiment, the upper wall of the oil groove 2 and hence a flange 6 of the cylinder liner 1 are not deflected by the clamp-down load of the head gasket 5 even if the groove 2 is formed at a position close to the top surface of the cylinder block 3. In other words, at the top deck of the cylinder block 3 to which the water jacket 8 cannot extend, the cylinder liner 1 on the block 3 which receives a great amount of heat transmitted from the top ring on the piston 7 when the latter is near and at its top dead center position can be effectively cooled even if the top ring 4 is positioned near a top surface of a piston 7 so as to attain a high compression ratio, and the groove 2 is formed on the block 3 at a correspondingly elevated position.

Though the depth-defining side wall of the oil groove 2 is substantially aligned with the cylindrical load plane a of the seal ring on the head gasket 5 in the above embodiment, the depth-defining side wall of the groove 2 may extend slightly deeper beyond the load plane a to an extent that the clamp-down load of the gasket 5 does not act as a bending load on the upper wall of the groove 2. In general, the oil groove 2 is required to have a certain cross sectional area in order to effectively cool the cylinder liner 1; moreover, if the oil groove 2 were too shallow, it would excessively resist the flow of oil, failing to obtain the expected cooling effect. In these respects, the oil groove 2 of the embodiment, which is formed to have a depth-defining side wall substantially aligned with the load plane a of the seal ring on the head gasket 5, provides the required cross sectional area and the required groove depth without enlarging the top deck of the cylinder block 3.

As is clear from the foregoing, according to the invention, the oil groove through which oil is circulated to cool the cylinder liner which in turn receives a great amount of heat transmitted from the top ring on the piston when the latter is near and at its top dead center position, is formed to have a depth-defining side wall which does not substantially extend deeper beyond the load plane of the seal ring on the head gasket so that the clamp-down load of the gasket is prevented from acting as a bending load on the upper wall of the oil groove. Therefore, even if the top ring is arranged at an elevated position in order to attain a high compression ratio, the oil groove can be arranged at a correspondingly elevated position so that the cylinder liner which receives a great amount of heat transmitted from the top ring on the piston when the latter is near and at its top dead center position can be reliably cooled without the risk of deforming the cylinder block and/or the cylinder liner.

What is claimed is:

1. A cooling system for a cylinder liner comprising an oil groove formed on a top deck of a cylinder block to surround a cylinder liner and means for circulating engine oil through said oil groove, said oil groove being formed so as not to substantially extend beyond cylindrical load plane of a seal ring on a head gasket.
